(19) United States
(12) Patent Application Publication
(10) Pub. No.: US 2009/0085829 A1
(43) Pub. Date: Apr. 2, 2009

(54) DISPLAY APPARATUS AND METHOD FOR COMPENSATING BEAM ALIGNMENT

(75) Inventors: In-Jae Yeo, Yongin-si (KR); Kyu-Bum Han, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd, Suwon (KR)

(21) Appl. No.: 12/208,306

(22) Filed: Sep. 10, 2008

(30) Foreign Application Priority Data
Sep. 27, 2007 (KR) 10-2007-0097154

(51) Int. Cl. G09G 5/00; G09G 3/34

(52) U.S. Cl. 345/1.1; 345/84

(57) ABSTRACT

A display apparatus compensating the discrepancy of alignment of beams irradiated on one-dimensional diffraction type optical modulator is disclosed. A 1-panel display apparatus including: a plurality of monochromatic light sources irradiating illumination light beams having different wavelengths; an optical modulator receiving sequentially the illumination light beams and modulating the illumination light beams according to a control signal; a scanner scanning the modulated illumination light beams sequentially on a display screen; and a control unit receiving an image signal and outputting a control signal for controlling the monochromatic light source, the optical modulator and the scanner in correspondence to the image signal, whereas the control unit controls an on/off timing of the monochromatic light source and an image data timing of the optical modulator in such a manner that a position of the modulated illumination light beam is equal to a position of a monochromatic image scanned on the display screen.

### CROSS-REFERENCE TO RELATED APPLICATION

This application claims the benefit of Korean Patent Application No. 10-2007-0097154, filed with the Korean Intellectual Property Office on Sep. 27, 2007, the disclosure of which is incorporated herein by reference in its entirety.

### BACKGROUND

1. Technical Field

The present invention relates to a display apparatus, more particularly to a display apparatus compensating the discrepancy of alignment of beams irradiated on one-dimensional diffraction type optical modulator.

2. Description of the Related Art

Generally, an optical signal processing has advantages of a high speed, parallel processing ability and high-capacity information processing in contrast to conventional digital information processing incapable of processing a large amount of data in real time. In addition, research has been devoted to application of the optical signal processing to a design and manufacture of a binary phase filter, an optical logic gate, an optical amplifier, an optical element and an optical modulator. The optical modulator is used in fields such as an optical memory, an optical display, a printer, an optical interconnection and a hologram and the like, and research and development have been devoted to an optical beam scanning apparatus using the optical modulator.

Such an optical beam scanning apparatus in an image forming apparatus, for example, a laser printer, an LED printer, an electronic picture copy machine, a word processor and a projector and the like, scans an optical beam and then spots the optical beam on a photosensitive medium and performs a function of forming an image.

As a projection TV, etc. have been recently developed, the optical beam scanning apparatus is used as a means for scanning a beam onto an image display.

One-dimensional diffraction type optical modulator used in a scanning display apparatus, i.e., a kind of a display apparatus is formed of a plurality of micro-mirrors arranged in a line and outputs a modulated light beam corresponding to a linear image. In this case, in order to represent a light intensity of a pixel, micro-mirrors change their displacements in response to a driving signal (i.e., a driving voltage), so that a quantity of the modulated light beam is changed. Such a modulated light beam is scanned on a screen through a scanner, and then two-dimensional or three-dimensional display image is formed.

That is, illumination light beam is irradiated in the form of a line beam on the one-dimensional diffraction type optical modulator from the light source. An illumination light beam according to each color is irradiated for the purpose of forming a color display image. When positions of the one-dimensional diffraction type optical modulator, on which the illumination light beams incident do not agree with each other in accordance with their colors, in other words, when there is an error in the beams alignment, display images are finally formed onto different positions of the screen according to their colors.

An acceptable error of the discrepancy of alignment of the beams in the optical modulator is ordinarily not equal to and less than 10 μm. Accordingly, illumination light beams from a monochromatic light source should be very precisely discrepant with each other when an optical module is assembled, which is a very difficult process. When the illumination light beams from the monochromatic light source are discrepantly aligned with each other and deviated, assembled finished products have defectiveness so that failure cost is increased, high precision of assembly equipments is required and assembling time is increased.

### SUMMARY

The present invention provides a method capable of digitally compensating the discrepancy of beam alignment of a monochromatic light source and a display apparatus applying the same.

An aspect of the present invention features a 1-panel display apparatus including: a plurality of monochromatic light sources irradiating illumination light beams having different wavelengths; an optical modulator receiving sequentially the illumination light beams and modulating the illumination light beams in accordance with a control signal; a scanner scanning the modulated illumination light beams sequentially on a display screen; and a control unit receiving an image signal and outputting a control signal for controlling the monochromatic light source, the optical modulator and the scanner in correspondence to the image signal, whereas the control unit controls an on/off timing of the monochromatic light source and an image data timing of the optical modulator in such a manner that a position of the modulated illumination light beam is equal to a position of a monochromatic image scanned on the display screen.

The on/off timing can be synchronized with the image data timing

The scanner can rotate unidirectionally or bidirectionally.

A scanning direction is from one side to the other. The control unit can control the on/off timing and the image data timing to be slow when the monochromatic scanned image is shifted to the one side, and control the on/off timing and the image data timing to be fast when the monochromatic scanned image is shifted to the other side

The monochromatic scanned image can include both a frame area representing image information and an over-scan area at both sides of the frame area in accordance with mechanical drive characteristics of the scanner. Here, the control unit can vary the size of the over-scan area provided at both sides of the frame area in accordance with a degree of shift of the monochromatic scanned image.

Another aspect of the present invention features a multi-panel display apparatus including: a plurality of monochromatic light sources irradiating illumination light beams having different wavelengths; a plurality of optical modulators receiving the illumination light beams and modulating the illumination light beams in accordance with a control signal; a color synthesis optical system synthesizing the modulated illumination light beams; a scanner scanning the light beam synthesized by the color synthesis optical system on a display screen; and a control unit receiving an image signal and outputting a control signal for controlling a plurality of the monochromatic light sources, a plurality of the optical modulators and the scanner in correspondence to the image signal, whereas the control unit controls an on/off timing of the monochromatic light source and an image data timing of the optical modulator in such a manner that a position of the modulated illumination light beam is equal to a position of a monochromatic image scanned on the display screen.

Yet another aspect of the present invention features a method for compensating a beam alignment in a display apparatus in which light beams are sequentially irradiated from a plurality of monochromatic light sources and an illumination light beam modulated by an optical modulator is scanned on a display screen, the method including: judging a degree of shift of a monochromatic scanned image formed on the display screen; and determining a frame image output timing of the monochromatic scanned image on the basis of a scanning direction of the monochromatic scanned image and the degree of shift.

A scanning direction of the determining is from one side to the other. The determining can control the on/off timing of the monochromatic light source and the image data timing of the optical modulator to be slow when the monochromatic scanned image is shifted to the one side, and control the on/off timing and the image data timing to be fast when the monochromatic scanned image is shifted to the other side.

Meanwhile, a method for compensating a beam alignment can be executed by a computer and can be recorded on a computer-readable recording medium for recording a program to be executed by the computer.

Another aspect as well as the description mentioned above, a characteristic, an advantage will be clear with the following drawings, claims and detailed description of the present invention.

### BRIEF DESCRIPTION OF THE DRAWINGS

FIG. 1 is a view illustrating a configuration of 1-panel display apparatus according to an embodiment of the present invention.

FIG. 2 is a solid perspective view illustrating an optical modulator including a plurality of micro-mirrors.

FIG. 3 is a plan view illustrating an optical modulator including a plurality of micro-mirrors illustrated in FIG. 2.

FIG. 4 is a view illustrating a case where illumination light beams incident on an optical modulator are discrepantly aligned with each other.

FIG. 5 is a view illustrating an image distortion resulting from that illumination light beams are discrepantly aligned with each other in accordance with their colors.

FIG. 6 is a view illustrating a configuration of a display apparatus in which illumination light beams are discrepantly aligned with each other in accordance with their colors.

FIG. 7 is a block diagram illustrating a control unit of 1-panel display apparatus according to an embodiment of the present invention.

FIG. 8 is a view illustrating scanned images before and after compensating a beam alignment at the time of the unidirectional scanning in a 1-panel display apparatus according to an embodiment of the present invention.

FIG. 9 is a view illustrating image data output timings and light source on/off timing signals before and after compensating a beam alignment in accordance with a scanner driving signal.

FIG. 10 is a view illustrating scanned images before and after compensating a beam alignment at the time of the bidirectional scanning in a 1-panel display apparatus according to an embodiment of the present invention.

FIG. 11 is a view illustrating image data output timings and light source on/off timing signals before and after compensating a beam alignment in accordance with a scanner driving signal.

FIG. 12 is a view illustrating a configuration of a 3-panel display apparatus according to another embodiment of the present invention.

FIG. 13 is a view illustrating scanned images before and after compensating a beam alignment at the time of the unidirectional scanning in a 3-panel display apparatus according to another embodiment of the present invention.

FIG. 14 is a view illustrating image data output timings and light source on/off timing signals before and after compensating a beam alignment in accordance with a scanner driving signal.

FIG. 15 is a view illustrating scanned images before and after compensating a beam alignment at the time of the bidirectional scanning in a 3-panel display apparatus according to another embodiment of the present invention.

FIG. 16 is a view illustrating image data output timings and light source on/off timing signals before and after compensating a beam alignment in accordance with a scanner driving signal.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description of the present invention, the detailed description of known technologies incorporated herein will be omitted when it may make the subject matter unclear.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

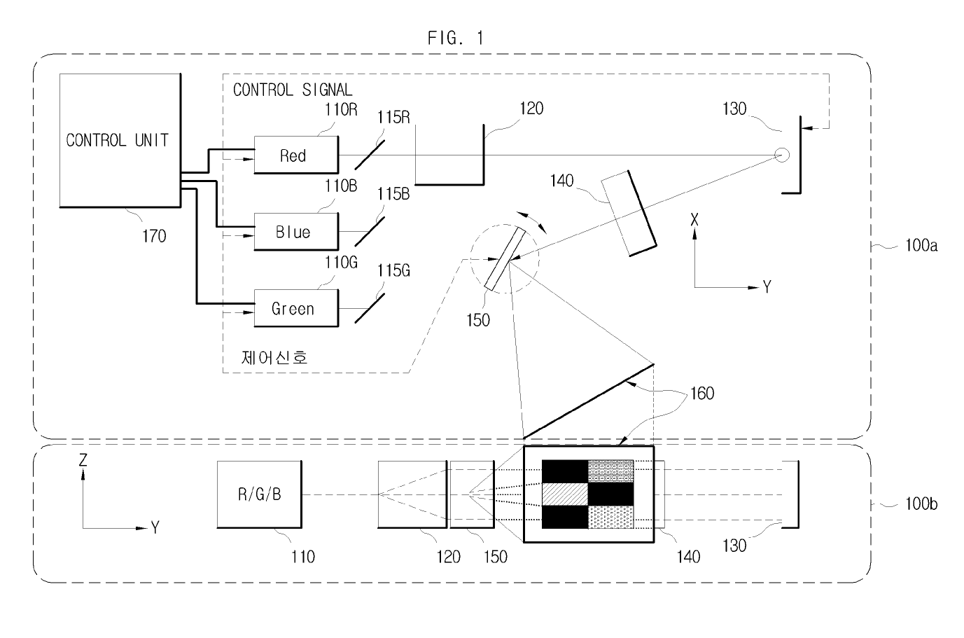

FIG. 1 illustrates a configuration of 1-panel display apparatus according to an embodiment of the present invention. An arrangement 100A on the X-Y plane of the 1-panel display apparatus and an arrangement 100B on the Y-Z plane of the 1-panel display apparatus are illustrated. A light source 110 (a red light source 11R, a green light source 110G, a blue light source 110B, mirror 115G, a first dichroic mirror 115R, a second dichroic mirror 115B, an illumination optical system 120, an optical modulator 130, an imaging optical system 140, a scanner 150, a display screen 160 and a control unit 170 are illustrated as well. Here, the panel refers to the optical modulator 130 modulating an illumination light beam. Since the number of the optical modulator 130 is one, the display apparatus corresponds to the 1-panel display apparatus.

The light source 110 irradiates a beam of light. The light source 110 can be a laser, an LED, a laser diode and the like.

According to an embodiment, the light source 110 irradiates a white light beam. In this case, a color separating unit (not shown) is provided to separate the white light beam into a red light beam, a green light beam and a blue light beam.

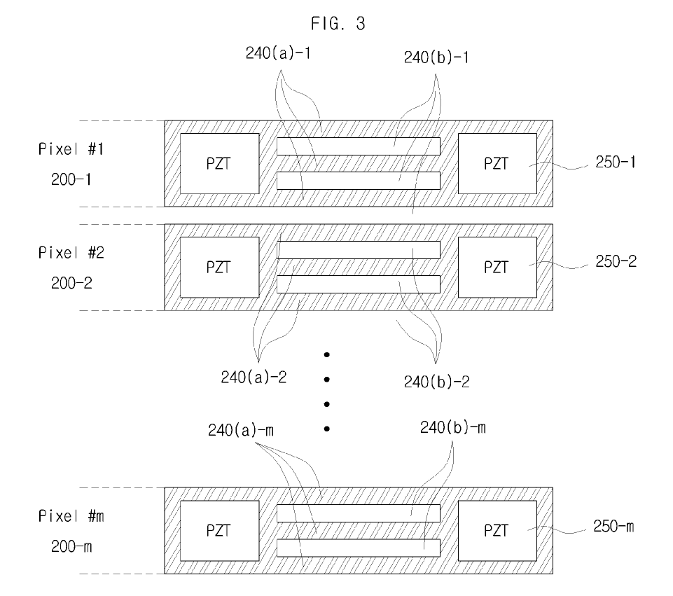

According to another embodiment, the light source 110 is, as illustrated in FIG. 3, separated into a red light source 110R, a blue light source 110B and a green light source 110G, so that three primary colors, i.e., a red light beam, a blue light beam and a green light beam are irradiated by the light source 110. Here, the red color, the green color and the blue color are no more than an embodiment. If various colors can be expressed through combination of color lights, a combination of other color lights is possible.

The illumination light system 120 is located between the light source 110 and the optical modulator 130. The illumination light system 120 adjusts a direction of a beam of light irradiated by the light source 110 and causes the beam of light to be focused on the optical modulator 130.

When the light source 110 is, as illustrated, formed of the red light source 110R, the blue light source 110B and the green light source 110G, both a mirror 115G for changing an optical path and dichroic mirrors 115R and 115B that reflect a light beam having a specified wavelength and transmit light beams having other wavelengths are provided in order that the illumination light beam irradiated by the each monochromatic light source can be input to the illumination optical system 120 along the same optical path.

The mirror 115G illustrated in FIG. 1 reflects the green light beam at a predetermined angle. The first dichroic mirror 115R transmits the red light beam and reflects the blue light beam and the green light beam at a predetermined angle. The second dichroic mirror 115B transmits the green light beam and reflects the blue light beam at a predetermined angle. Characteristics of the mirrors and the dichroic mirrors can be changed according to the structure in which the monochromatic light sources are arranged respectively.

The optical modulator 130 modulates the illumination light beam irradiated by the light source 110 and outputs the modulated light beam in accordance with the control signal from the control unit 170. The optical modulator 130 is formed of a plurality of micro-mirrors arranged in parallel, which correspond to linear image corresponding to a vertical line or a horizontal line in frame of an image formed on the display screen 160. That is, the optical modulator 130 changes the displacement of each micro-mirror corresponding to each pixel of the linear image in accordance with the control signal, so that optical modulator outputs the modulated light beam in which each pixel has various quantities of light.

The number of the micro-mirrors is more than the number of pixels forming the linear image. One micro-mirror can represent one pixel or a plurality of adjacent micro-mirrors can represent one pixel. The modulated light beam is a line beam reflecting image information (that is, a luminance value of each pixel forming the linear image) of the linear image to be later formed on the display screen 160, and can be a 0^{th} order diffracted light, +N^{th} order diffracted light or −N^{th} order diffracted light, n being a natural number.

A drive circuit is further included so that a driving signal (for example, a driving voltage or a driving current, etc.) corresponding to the control signal of the control unit 170 is provided to each micro-mirror of the optical modulator 130 in such a manner that the displacement can be changed.

The modulated light beam from the optical modulator 130 is input to the scanner 150 via the imaging optical system 140. The imaging optical system 140 can include one or more lenses and transmits the modulated light beam by adjusting magnification according to a ratio of the size of the optical modulator 130 to the size of the scanner 150. Additionally, the imaging optical system 140 receives one of the diffracted light beams of a plurality of diffraction orders, which are outputted from the optical modulator 130.

The scanner 150 reflects the modulated light beam corresponding to the linear image and projects the modulated light beam on the display screen 160. The scanner 150 rotates according to the control signal from the control unit 170, reflects the modulated light beam according to time and changes the position where the modulated light beam is projected on the display screen 160, such that a plurality of linear images are projected and one two-dimensional image or one three-dimensional image is displayed as a whole. The scanner 150 can be a polygon mirror rotating unidirectionally, a rotating bar rotating unidirectionally or a galvano mirror rotating bidirectionally, etc.

The control unit 170 generates and outputs a control signal for controlling the light source 110, the optical modulator 130, and the scanner 150 in accordance with the input image information. The control unit classifies two-dimensional image information or three-dimensional image information as information about a plurality of linear images and controls the drive angle of the scanner 150 with respect to information about each linear image so that light modulated by the optical modulator 130 is projected on the position corresponding to the corresponding linear image on the display screen 160.

The optical modulator 130 applied to the present invention will be described below. The optical modulator 130 modulates a beam of light by using a method of controlling on/off of light or a method of using a reflection/diffraction. The method of using a reflection/diffraction can be classified into an electrostatic method and a piezoelectric method. The optical modulator will be described focusing on the piezoelectric method in the following description. However, the electrostatic method is also applicable in the same way.

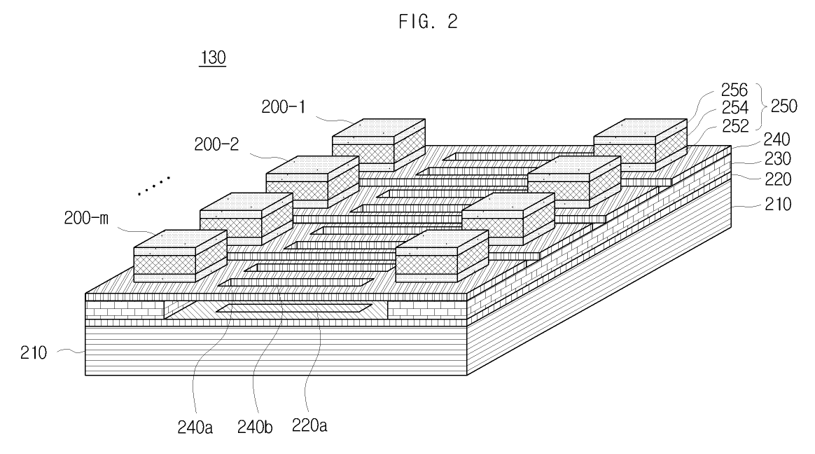

A micro-mirror included in an open-hole structural optical modulator is illustrated in FIG. 2 and FIG. 3. FIG. 2 illustrates a solid perspective view of an optical modulator including a plurality of micro-mirrors. FIG. 3 illustrates a plan view of an optical modulator including a plurality of the micro-mirrors illustrated in FIG. 2. In this embodiment, it is assumed that one micro-mirror is responsible for one pixel.

A plurality of micro-mirrors 200-1, 200-2, . . . 200-m (hereinafter, commonly designated as 200) are arranged in a line. Each micro-mirror includes a substrate 210, an insulation layer 220, a sacrifice layer 230, a ribbon structure 240 and a piezoelectric substance 250.

The insulation layer 220 is laminated on the substrate 210. The sacrifice layer 230 separates the ribbon structure 240 from the insulation layer 220 as long as a certain gap. The ribbon structure 240 interferes with an incident illumination light beam and optically modulates a signal. The ribbon structure 240 can have a plurality of open-holes 240B in its central part. While the open-hole 240B having a long rectangular shape in the direction of the length of the micro-mirror 200 is illustrated, various shapes such as a circular shape, an elliptic shape, etc. can be applied to the open-hole 240B. Additionally, a large number of the long rectangular shaped open-holes can be arranged in parallel with each other in the direction of the width of the micro-mirror 200.

The piezoelectric substance 250 is formed of a lower electrode 252, a piezoelectric layer 254 and an upper electrode 256, and controls the ribbon structure 240 to move up and down in accordance with the degree of the contraction or dilation in the direction of up and down or right and left, which is generated by voltage difference between the upper part electrode and the lower part electrode. The reflective layer 220A can be formed in correspondence to the hole 240B formed on the ribbon structure 240 or can be formed on the whole insulation layer.

For example, when the wavelength of a beam of light is X, a first voltage is applied to the piezoelectric substance 250 in such a manner that a gap between the upper reflective layer 240A formed on the ribbon structure 240 and the lower reflective layer 220A formed on the insulation layer 220 can be (2 l)λ/4, l being a natural number. At this time, in case of zero order diffracted light, a total path difference between the light reflected from the upper reflective layer 240A and the light reflected from the lower reflective layer 220A is equal to lλ, so that a constructive interference occurs. Accordingly, the modulated light has the maximum luminance (that is, the maximum quantity of light). In case of +1^{st} order and −1^{st} order diffracted lights, the beam of light has the minimum luminance (that is, the minimum quantity of light) through a destructive interference.

Also, a second voltage is applied to the piezoelectric substance 250 in such a manner that a gap between the upper reflective layer 240A formed on the ribbon structure 240 and the lower reflective layer 220A formed on the insulation layer 220 can be (2 l+1)λ/4, l being a natural number. At this time, in case of zero order diffracted light, a total path difference between the light reflected from the upper reflective layer 240A and the light reflected from the lower reflective layer 220A is equal to (2 l+1)λ/2, so that a destructive interference occurs. Accordingly, the modulated light has the minimum luminance (that is, the minimum quantity of light). In case of +1^{st} order and −1^{st} order diffracted lights, the light has the maximum luminance (that is, the maximum quantity of light) value through a constructive interference.

As a result of the interference mentioned above, the micro-mirror is able to load a signal of one pixel on the beam of light by adjusting the quantity of the diffracted light. A case where the gap between the ribbon structure 240 and the insulation layer 220 is either (2 l)λ/4 or (2 l+1)λ/4 has been described in the foregoing description. However, the luminance of light interfered by diffraction and reflection of the incident illumination light can be controlled through adjustment of the gap between the ribbon structure 240 and the insulation layer 220. Zero order diffracted light, +N^{th} order diffracted light, −N^{th} order diffracted light, etc., n being a natural number, correspond to the modulated light.

The optical modulator 130 has an m number of micro-mirrors 200-1, 200-2, . . . . 200-m, which respectively are responsible for a pixel #1, a pixel #2, . . . , a pixel #m. The optical modulator 130 deals with information about the linear image of the vertical line (here, it is assumed that the vertical line is formed of m numbers of pixels, and each of micro-mirrors 200-1, 200-2, . . . , 200-m deals with one of m numbers of pixels constituting the vertical line. Accordingly, the light beam reflected and/or diffracted by each micro-mirror is then projected by the scanner 150 on the screen as a two-dimensional or three-dimensional image.

While an optical modulator having the open-hole structure in which the open-holes are provided so that one micro-mirror deals with one pixel has been described as illustrated in FIGS. 2 and 3, multiple micro-mirrors can deal with one pixel as well. In a micro-mirror without the open-hole, it is possible to use a reflected light path difference according to the difference between height of a micro-mirror of an even number and height of a micro-mirror of an odd number among a large number of micro-mirrors. In addition, it should be understood by those skilled in the art that optical modulators of various types are applicable to the present invention.

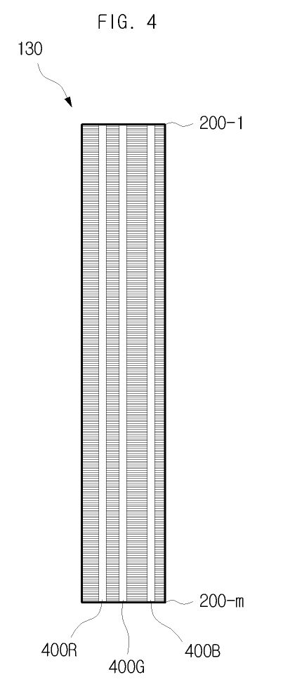

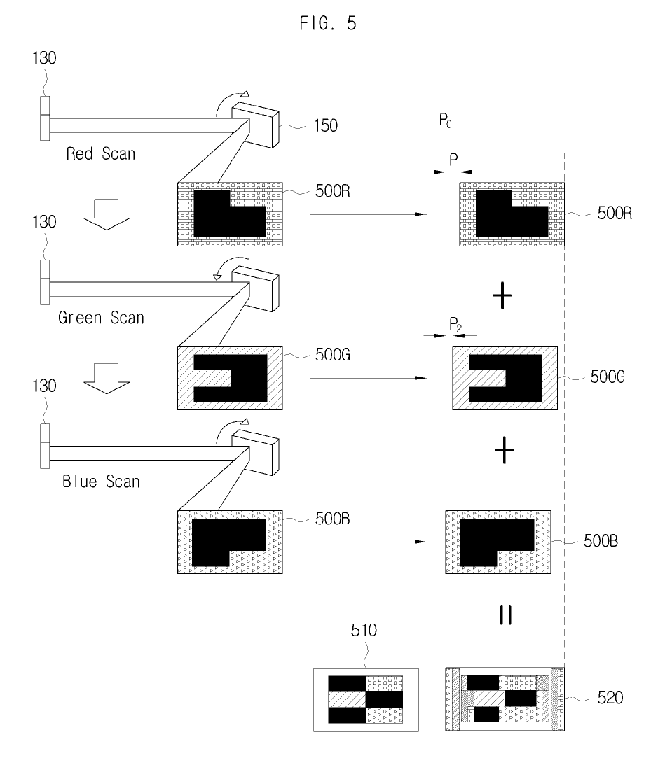

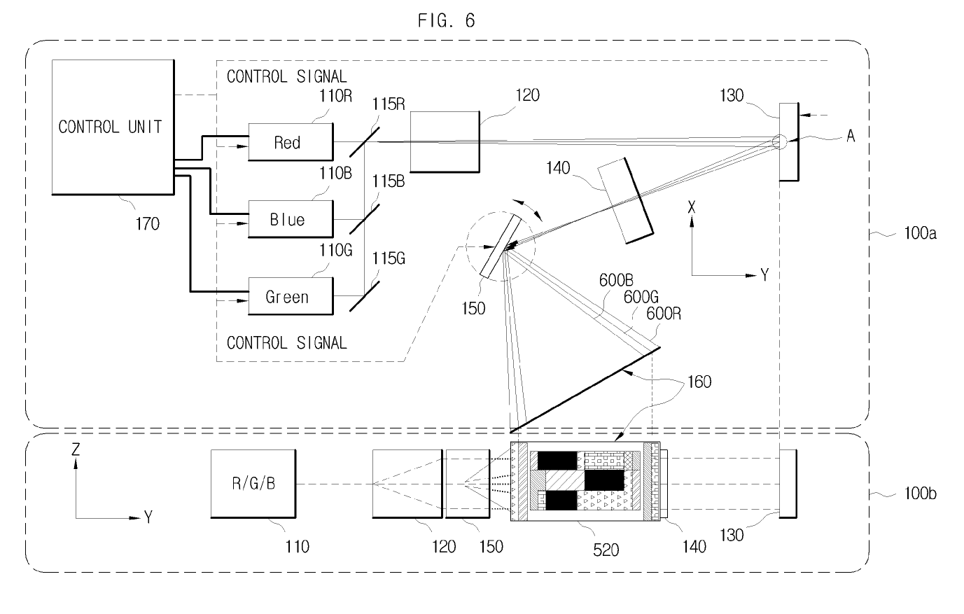

FIG. 4 illustrates a case where illumination light beams incident on an optical modulator are discrepantly aligned with each other. FIG. 5 illustrates an image distortion resulting from that illumination light beams are discrepantly aligned with each other in accordance with their colors. FIG. 6 illustrates a configuration of a display apparatus in which illumination light beams are discrepantly aligned with each other in accordance with their colors.

M number of micro-mirrors from a first micro-mirror 200-1 to an m^{th} micro-mirror 200-m are arranged in the optical modulator 130 in parallel with each other. After a red light beam 400R, a green light beam 400G and a blue light beam 400B are incident on such an optical modulator 130, the beams are outputted as diffracted light beams having linear image information in accordance with drive of each micro-mirror as described above.

In this case, the red light beam 400R, the green light beam 400G and the blue light beam 400B are incident on the optical modulator 130 and are aligned differently from each other as illustrated in FIG. 4. Subsequently, FIG. 5 illustrates the result of FIG. 4.

It is assumed that the illumination light beams are incident on the optical modulator 130 in order of a red light beam, a green light beam and a blue light beam in the present embodiment. A modulated red light beam outputted by the optical modulator 130 forms a red image 500R through the scanner 150. A modulated green light beam outputted by the optical modulator 130 forms a green image 500G through the scanner 150. A modulated blue light beam outputted by the optical modulator 130 forms a blue image 500B through the scanner 150.

Here, when a reference line for showing the most left vertical line on the display screen 160 is P0 because the incident points of the illumination light beams are different from each other, the red image 500R is shown leaning to the right as much as P1, and the green image 500g is shown leaning to the right as much as P2. For this reason, there is a problem that a distorted color image 520 is formed, compared with a target color image 510 intended to be formed on the display screen 160.

Referring to FIG. 6, at least one of the red light beam, the green light beam and the blue light beam is discrepantly aligned with the others at a point of “A” on the optical modulator 130, so that at least one of a red image 600R, a green image 600G and a blue image 600B is shifted on the basis of a reference line. Consequently, a distorted color image 520 is formed. While light beams are mechanically adjusted to be aligned from the light source 110 to the optical modulator 130, identically to each other in the conventional time so as to solve such a problem, a control unit 170 is designed to solve the problem in a digital manner in the present invention.

In the present invention, the display apparatus scans a one-dimensional linear image and forms a two or three dimensional image. It is assumed that the linear image is a vertical line and scanning is performed in the right and left directions. Over-scan is performed as much as a certain amount in order to increase and decrease the speed of scanning. On/off timing of each color light source and output time of data stream are adjusted by using such an over-scan interval.

When an image being scanned from left to right is shifted to the right, the timings of the light source and the data stream are outputted fast enough to compensate the shifted amount. When an image being scanned from left to right is shifted to the left, the timings of the light source and the data stream are outputted slowly enough to compensate the shifted amount.

In addition, when an image being scanned from right to left is shifted to the right, the timings of the light source and the data stream are outputted so slowly as to compensate the shifted amount. When an image being scanned from right to left is shifted to the left, the timings of the light source and the data stream are outputted so fast enough to compensate the shifted amount.

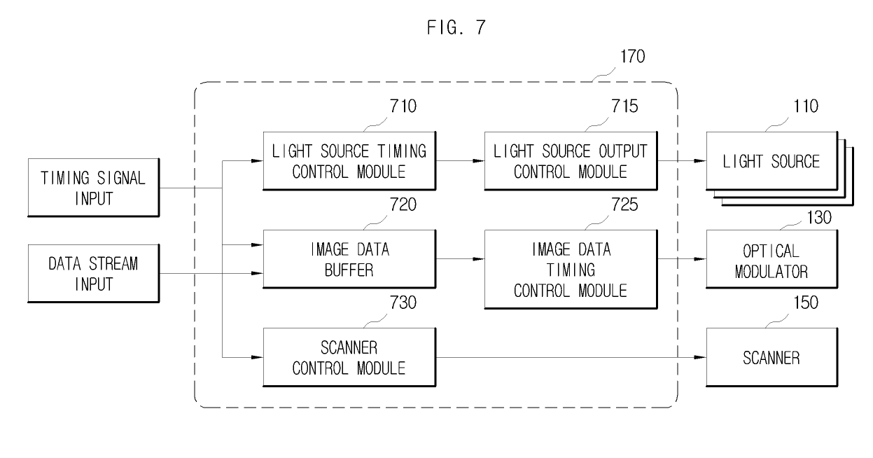

A configuration for controlling as described above the timings of the light source and the data stream is illustrated in FIG. 7. FIG. 7 illustrates a block diagram of a control unit 170 of a 1-panel display apparatus according to an embodiment of the present invention. The light source 110, the optical modulator 130, the scanner 150, a light source timing control module 710, a light source output control module 715, an image data buffer 720, an image data timing control module 725 and a scanner control module 730 are illustrated in FIG. 7.

The control unit 170 receives a timing signal and a data stream. When light beams are correctly aligned, the timing signal includes information about a light source timing, an image data timing and scanner drive angle timing which can allow the input data stream to be normally represented on the desired position of the display screen 160. The data stream includes image information about frames of color images intended to be formed on the display screen 160. Generally, data is input in order from a first horizontal line to a final horizontal line. The image data buffer 720 temporarily stores the image information about the input color image frames and outputs the image data stream by separating the image data stream by the vertical line.

The light source timing control module 710 generates a light source timing signal for controlling on/off timing of each monochromatic light source by using the input timing signal and shift information described above. The light source output control module 715 controls the output of each monochromic light source.

The image data timing control module 725 controls the image data timing separated by the vertical line, i.e., a modulation timing of the optical modulator 130 by using the input timing signal and shift information described above.

Here, it is preferable to synchronize the light source on/off timing with the image data timing.

The scanner control module 730 controls the scanner 150 to have a predetermined drive angle and a drive speed and to rotate unidirectionally or bidirectionally in accordance with the input timing signal.

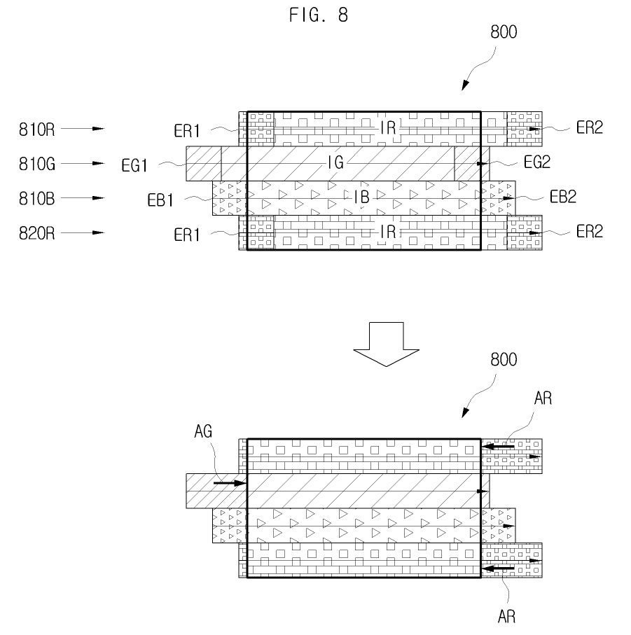

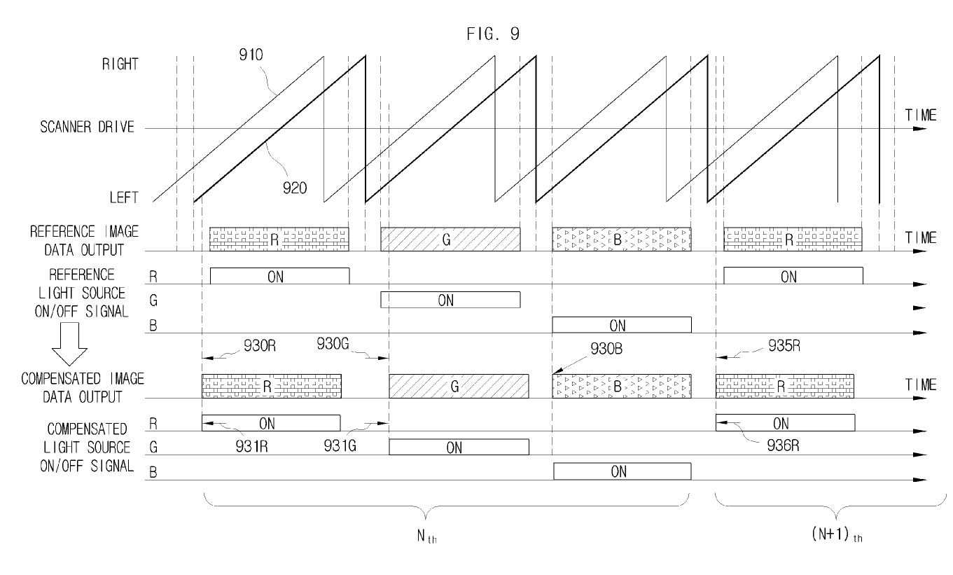

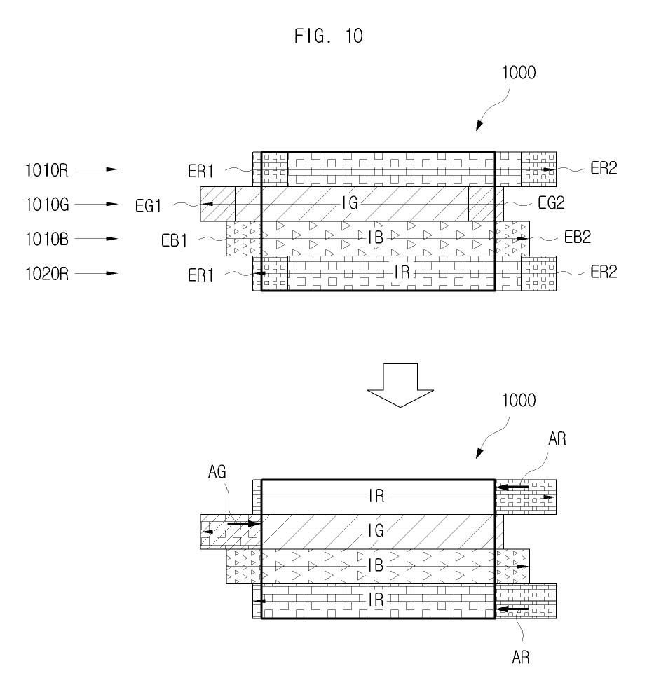

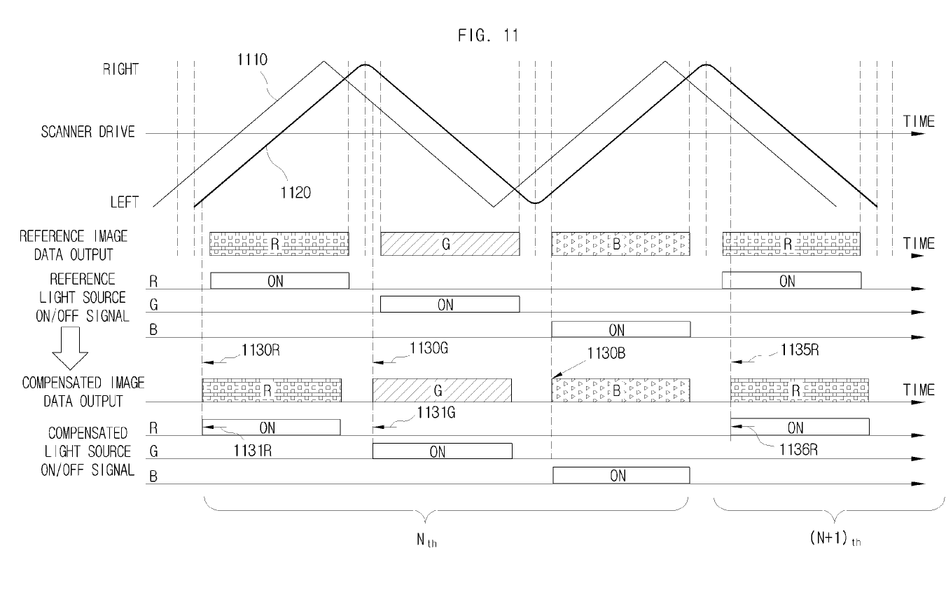

In the following description, a method for compensating a beam alignment at the time of the unidirectional scanning will be described with reference to FIG. 8 and FIG. 9. Also, a method for compensating a beam alignment at the time of the bidirectional scanning of a bidirectional scanning will be described with reference to FIG. 10 and FIG. 11.

FIG. 8 illustrates scanned images before and after compensating a beam alignment at the time of the unidirectional scanning in a 1-panel display apparatus according to an embodiment of the present invention. FIG. 9 illustrates image data output timings and light source on/off timing signals before and after compensating a beam alignment in accordance with a scanner driving signal.

A scanned reference image 800, i.e., a reference for aligning a beam provides shift information of the scanned image according to each color. It is assumed that the scanning is performed in order of a red image, a green image and a blue image, and from left to right. A monochromatic scanned image includes both a frame area representing image information and an over-scan area at both sides of the frame area in accordance with mechanical drive characteristics of the scanner.

A red scanned image 810R includes a left over-scan area ER1, a frame area IR and a right over-scan area ER2. The frame area IR is shifted to the right on the basis of the scanned reference image 800. In this case, the frame area IR should be outputted as fast as “AR” in order to compensate the beam alignment.

A green scanned image 810G includes a left over-scan area EG1, a frame area IG and a right over-scan area EG2. The frame area IG is shifted to the left on the basis of the scanned reference image 800. In this case, the frame area IG should be outputted as slowly as “AG” in order to compensate the beam alignment.

The blue scanned image 810B includes a left over-scan area EB1, a frame area IB and a right over-scan area EB2. The frame area IB is normally included within the scanned reference image 800, which signifies that the blue light beam irradiated by the blue light source is correctly aligned on the optical modulator.

That is, the beam alignment is compensated by varying the size of the over-scan area provided at both sides of the frame area in accordance with a degree of shift of the monochromatic scanned image.

One color image frame is completed as the red scanned image 810R, the green scanned image 810G and the blue scanned image 810B are respectively scanned one time, and then the red scanned image 820R is scanned again so that the next color image frame is completed.

Referring to FIG. 9, an actual drive 920 of the scanner is completed after a certain time delay according to the scanner driving signal 910. When the scanner is driven one time, there exists an over-scan area for increasing and decreasing the speed of the scanner at both a scanning starting point and a scanning finishing point.

A reference light source on/off signal of each monochromatic light source and a reference image data output before compensating the beam alignment are located at the center of the graph illustrating the actual drive 920 of the scanner. Here, when the reference image data output is red, only the red light source is in an ON-state, and the same is true of green and blue as well.

On the assuming that the scanning is performed from left to right, since the red scanned image 810R is shifted to the right as illustrated in FIG. 8, a compensated image data output point of time is earlier than a reference image data output point of time (see 930R). The on-signal of the red light source is also outputted earlier than a reference signal (see 931R). Since the green scanned image 810G is shifted to the left, a compensated image data output point of time is later than the reference image data output point of time (see 930G). The on-signal of the green light source is also outputted later than the reference signal (see 931G). Since the blue scanned image 810B is not shifted, a compensated image data output point of time is equal to the reference image data output point of time (see 930B). The on-signal output of the blue light source is also the same as the reference signal output (see 931B).

Thereafter, in the next frame, since the red scanned image 820R is shifted to the right, the compensated image data output point of time is earlier than the reference image data output point of time (see 935R). The on-signal of the red light source is also outputted earlier than the reference signal (see 936R).

FIG. 10 illustrates scanned images before and after compensating a beam alignment at the time of the bidirectional scanning in a 1-panel display apparatus according to an embodiment of the present invention. FIG. 11 illustrates image data output timings and light source on/off timing signals before and after compensating a beam alignment in accordance with a scanner driving signal.

A scanned reference image 1000, i.e., a reference for aligning a beam provides shift information of the scanned image according to each color. It is assumed that the scanning is performed in order of a red image, a green image and a blue image, and is performed from left to right and right to left.

A red scanned image 1010R being scanned from left to right includes a left over-scan area ER1, a frame area IR and a right over-scan area ER2. The frame area IR is shifted to the right on the basis of the scanned reference image 1000. In this case, the frame area IR should be outputted as fast as “AR” in order to compensate the beam alignment.

A green scanned image 1010G being scanned from right to left includes a left over-scan area EG1, a frame area IG and a right over-scan area EG2. The frame area IG is shifted to the left on the basis of the scanned reference image 1000. In this case, the frame area IG should be outputted as fast as “AG” in order to compensate the beam alignment.

The blue scanned image 1010B includes a left over-scan area EB1, a frame area IB and a right over-scan area EB2. The frame area IB is normally included within the scanned reference image 1000, which signifies that the blue light beam irradiated by the blue light source is correctly aligned on the optical modulator.

One color image frame is completed as the red scanned image 1010R, the green scanned image 1010G and the blue scanned image 1010B are respectively scanned one time, and then the red scanned image 2020R is scanned again so that the next color image frame is completed.

A red scanned image 1020R of the next frame is scanned from right to left. The red scanned image 1020R is shifted to the right on the basis of the scanned reference image 1000. In this case, the frame area IR should be outputted as slowly as “AR” in order to compensate the beam alignment differently from the case of the previous frame because the scanning direction has been reversed.

Referring to FIG. 11, an actual drive 1120 of the scanner is completed after a certain time delay according to a scanner driving signal 1110. When the scanner is driven one time, there exists an over-scan area for increasing and decreasing the speed of the scanner at both a scanning starting point and a scanning finishing point.

A reference light source on/off signal of each monochromatic light source and a reference image data output before compensating the beam alignment are located at the center of the graph illustrating the actual drive 1120 of the scanner. Here, when the reference image data output is red, only the red light source is in an ON-state, and the same is true of green and blue as well.

Here, the red scanned image 1010R being scanned from left to right is shifted to the right as illustrated in FIG. 10, a compensated image data output point of time is earlier than a reference image data output point of time (see 1130R). The on-signal of the red light source is also outputted earlier than a reference signal (see 1131R).

Since the green scanned image 1010G being scanned from right to left is shifted to the left, a compensated image data output point of time is earlier than the reference image data output point of time (see 1130G). The on-signal of the green light source is also outputted earlier than the reference signal (see 1131G).

Since the blue scanned image 1010B being scanned from left to right is not shifted, a compensated image data output point of time is equal to the reference image data output point of time (see 1130B). The on-signal output of the blue light source is also the same as the reference signal output (see 1131B).

Thereafter, in the next frame, since the red scanned image 1020R being scanned from right to left differently from the case of the previous frame is shifted to the right, the compensated image data output point of time is later than the reference image data output point of time (see 1135R). The on-signal of the red light source is also outputted later than the reference signal (see 1136R).

While the method for compensating the beam alignment in the 1-panel display apparatus has been described in the foregoing, a method for compensating the beam alignment in a 3-panel display apparatus will be described in the following description.

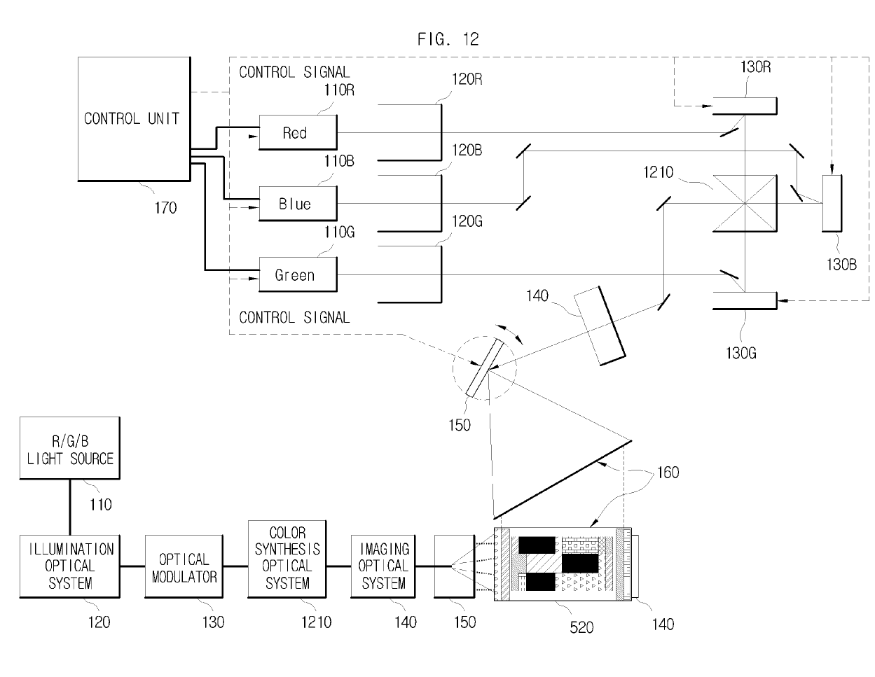

FIG. 12 illustrates a configuration of a 3-panel display apparatus according to another embodiment of the present invention.

FIG. 12 illustrates light sources 110 (a red light source 110R, a green light source 110G and a blue light source 110B), three illumination optical systems 120R, 120G and 120B, three optical modulators 130R, 130G and 130B, a color synthesis optical system 1210, an imaging optical system 140, a scanner 150, a display screen 160 and a control unit 170. Detailed description of elements performing the same/similar functions to the 1-panel display apparatus illustrated in FIG. 1 will be omitted for the sake of convenience of description and understanding of the present embodiment. The 3-panel display apparatus will be described focusing on the difference between the 1-panel display apparatus and the 3-panel display apparatus.

The 3-panel display apparatus includes three optical modulators 130R, 130G and 130B in contrast to the 1-panel display apparatus including one optical modulator 130. That is, the light source 110, the illumination optical system 120 and the optical modulator 130 are provided in accordance with each color.

The 1-panel display apparatus cannot represent image information about two or more colors at the same time. The 1-panel display apparatus sequentially represents a scanned image on the display screen one time with respect to the red light beam, the green light beam and the blue light beam so that color images can be formed on a time average.

In comparison, the 3-panel display apparatus can represent image information about three colors at the same time. The monochromatic light beams modulated by the three optical modulators 130R, 130G and 130B are synthesized by the color synthesis optical system 1210 and are scanned on the display screen 160 through the imaging optical system 140 and the scanner 150.

When illumination light beams incident on optical modulators 130R, 130G and 130B are not correctly aligned in such a 3-panel display apparatus, the illumination light beams are not synthesized by the color synthesis optical system 1210 so that a color image being displayed is eventually distorted.

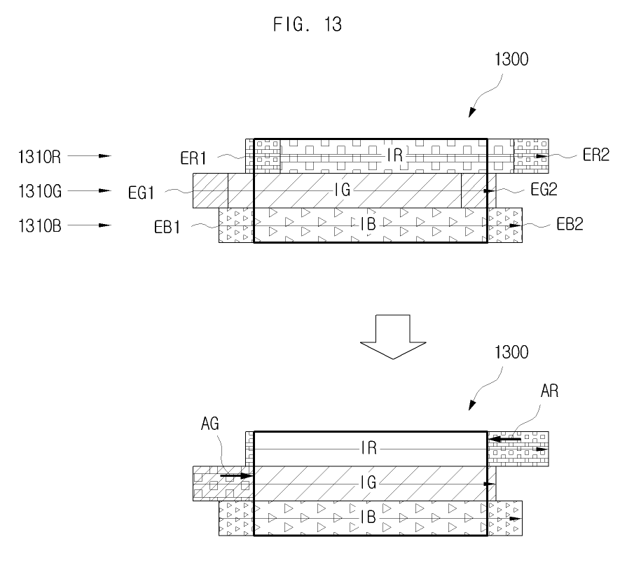

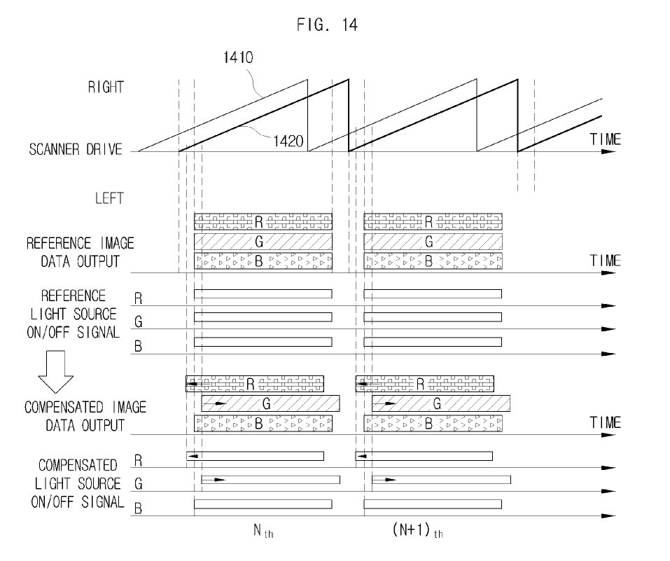

FIG. 13 illustrates scanned images before and after compensating a beam alignment at the time of the unidirectional scanning in a 3-panel display apparatus according to another embodiment of the present invention. FIG. 14 illustrates image data output timings and light source on/off timing signals before and after compensating a beam alignment in accordance with a scanner driving signal.

A scanned reference image 1300, i.e., a reference for aligning a beam provides shift information of the scanned image according to each color. It is assumed that a red image, a green image and a blue image are simultaneously scanned and are scanned from left to right.

A red scanned image 1310R includes a left over-scan area ER1, a frame area IR and a right over-scan area ER2. The frame area IR is shifted to the right on the basis of the scanned reference image 1300. In this case, the frame area IR should be outputted as fast as “AR” in order to compensate the beam alignment.

A green scanned image 1310G includes a left over-scan area EG1, a frame area IG and a right over-scan area EG2. The frame area IG is shifted to the left on the basis of the scanned reference image 1300. In this case, the frame area IG should be outputted as slowly as “AG” in order to compensate the beam alignment.

The blue scanned image 1310B includes a left over-scan area EB1, a frame area IB and a right over-scan area EB2. The frame area IB is normally included within the scanned reference image 1300, which signifies that the blue light beam irradiated by the blue light source is correctly aligned on the optical modulator 130B.

The red scanned image 1310R, the green scanned image 1310G and the blue scanned image 1310B are simultaneously scanned so that one color image frame is completed.

Referring to FIG. 14, an actual drive 1420 of the scanner is completed after a certain time delay according to the scanner driving signal 1410. When the scanner is driven one time, there exists an over-scan area for increasing and decreasing the speed of the scanner at both a scanning starting point and a scanning finishing point.

A reference light source on/off signal of each monochromatic light source and a reference image data output before compensating a beam alignment are located at the center of the graph illustrating the actual drive 1420 of the scanner. Here, when the reference image data output is red, only the red light source is in an ON-state, and the same is true of green and blue as well.

On the assuming that the scanning is performed from left to right, since the red scanned image 1310R is shifted to the right as illustrated in FIG. 13, a compensated image data output point of time is earlier than a reference image data output point of time (see 1430R). The on-signal of the red light source is also outputted earlier than a reference signal (see 1431R). Since the green scanned image 1310G is shifted to the left, a compensated image data output point of time is later than the reference image data output point of time (see 1430G). The on-signal of the green light source is also outputted later than the reference signal (see 1431G). Since the blue scanned image 1310B is not shifted, a compensated image data output point of time is equal to the reference image data output point of time (see 1430B). The on-signal output of the blue light source is also the same as the reference signal output (see 1431B).

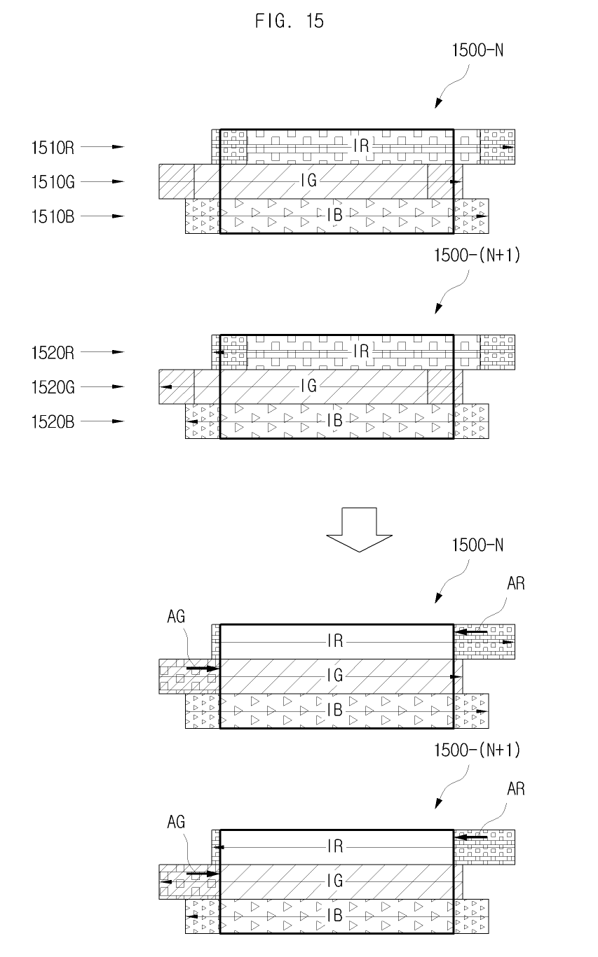

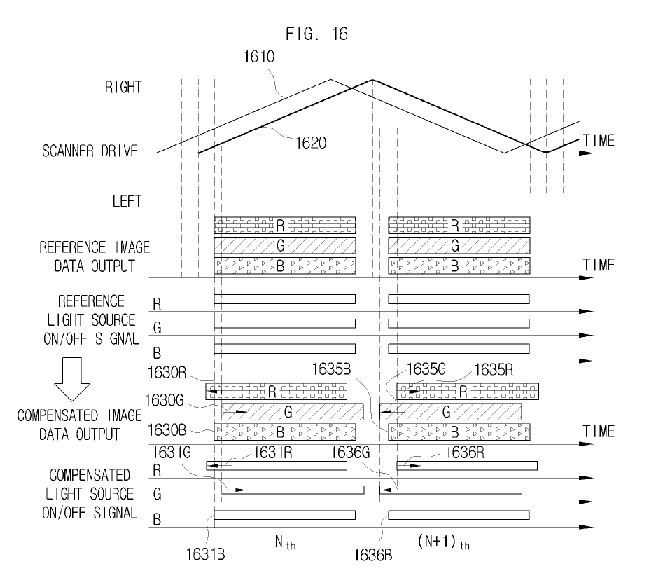

FIG. 15 illustrates scanned images before and after compensating a beam alignment at the time of the bidirectional scanning in a 3-panel display apparatus according to an embodiment of the present invention. FIG. 16 illustrates image data output timings and light source on/off timing signals before and after compensating a beam alignment in accordance with a scanner driving signal.

Scanned reference images 1500-N and 1500-(N+1), i.e., references for aligning a beam provide shift information of the scanned image based on each color in accordance with a frame. It is assumed that a red image, a green image and a blue image are simultaneously scanned and are scanned from left to right and right to left.

The scanning is performed from left to right in an N^{th} frame.

In a red scanned image 151R, a frame area IR is shifted to the right on the basis of the scanned reference image 1500-N. In this case, the frame area IR should be outputted as fast as “AR” in order to compensate the beam alignment.

In a green scanned image 1510G, a frame area IG is shifted to the left on the basis of the scanned reference image 1500-N. In this case, the frame area IG should be outputted as slowly as “AG” in order to compensate the beam alignment.

In a blue scanned image 1510B, a frame area IB is normally included within the scanned reference image 1500-N, which signifies that the blue light beam irradiated by the blue light source is correctly aligned on the optical modulator 130B.

As the red scanned image 1510R, the green scanned image 1510G and the blue scanned image 1510B are simultaneously scanned, an N^{th} color image frame is completed.

The scanning is performed from right to left in an (N+1)^{th} frame.

The frame area IR in a red scanned image 1520R is shifted to the right on the basis of the scanned reference image 1500-(N+1). In this case, the frame area IR should be outputted as slowly as “AR” in order to compensate the beam alignment because the scanning direction has been reversed.

The frame area IG in a green scanned image 1520G is shifted to the left on the basis of the scanned reference image 1500-(N+1). In this case, the frame area IG should be outputted as fast as “AG” in order to compensate the beam alignment because the scanning direction has been reversed.

The frame area IB in a blue scanned image 1520B is normally included within the scanned reference image 1500-(N+1), which signifies that a blue light beam irradiated by the blue light source is correctly aligned on the optical modulator 130B.

As the red scanned image 1520R, the green scanned image 1520G and the blue scanned image 1520B are simultaneously scanned, an (N+1)^{th} color image frame is completed.

Referring to FIG. 16, an actual drive 1620 of the scanner is completed after a certain time delay according to the scanner driving signal 1610. When the scanner is driven one time, there exists an over-scan area for increasing and decreasing the speed of the scanner at both a scanning starting point and a scanning finishing point.

A reference light source on/off signal of each monochromatic light source and a reference image data output before compensating the beam alignment are located at the center of the graph illustrating the actual drive 1620 of the scanner. Here, when the reference image data output is red, only the red light source is in an ON-state, and the same is true of green and blue as well.

Since the red scanned image 1510R of the N^{th} frame (scanning from left to right) is shifted to the right as illustrated in FIG. 15, a compensated image data output point of time is earlier than a reference image data output point of time (see 1630R). The on-signal of the red light source is also outputted earlier than a reference signal (see 1631R). Since the green scanned image 1510G is shifted to the left, a compensated image data output point of time is later than the reference image data output point of time (see 1630G). The on-signal of the green light source is also outputted later than the reference signal (see 1631G). Since the blue scanned image 1510B is not shifted, a compensated image data output point of time is equal to the reference image data output point of time (see 1630B). The on-signal output of the blue light source is also the same as the reference signal output (see 1631B).

Since the red scanned image 1520R of the (N+1)^{th} frame (scanning from right to left) is shifted to the right as illustrated in FIG. 15, a compensated image data output point of time is later than a reference image data output point of time (see 1635R). The on-signal of the red light source is also outputted later than a reference signal (see 1636R). Since the green scanned image 1520G is shifted to the left, a compensated image data output point of time is earlier than the reference image data output point of time (see 1635G). The on-signal of the green light source is also outputted earlier than the reference signal (see 1636G). Since the blue scanned image 1520B is not shifted, a compensated image data output point of time is equal to the reference image data output point of time (see 1635B). The on-signal output of the blue light source is also the same as the reference signal output (see 1636B).

The method for compensating the beam alignment in the 3-panel display apparatus has been described in the foregoing.

According to another embodiment of the present invention, it is possible to apply the above-mentioned method for compensating the beam alignment to a 2-panel display apparatus. In case of the 2-panel display apparatus, only the illumination light beam having one color is incident on one panel and an illumination light beam having the other two colors is incident on the other panel. Accordingly, it is possible to modify and apply the above-mentioned method for compensating the beam alignment in the 1-panel display apparatus to a panel on which the illumination light beam having two colors is incident, and possible to modify and apply the method for compensating the beam alignment in the 3-panel display apparatus to two panels.

Meanwhile, in the present invention, it is possible to compensate in such a manner that the positions of scanned images in accordance with each light beam of red, green and blue are respectively equal to the position of the scanned reference image because the position of the scanned reference image is preset on the display screen. On the other hand, on the basis of one of the red, green and blue light beams, it is also possible to compensate in such a manner that scanned images in accordance with the other light beams are equal to the scanned image in accordance with the reference light beam.

The above-described method for compensating the beam alignment can be implemented by computer programs. Program codes and code segments forming the programs can be easily inferred by computer programmers skilled in the art. The programs are stored in computer readable media and are read and executed by computers so that a method for providing a document-search service is implemented. The computer readable media includes a magnetic recording medium, an optical recording medium and a carrier wave medium.

While the present invention has been described focusing on exemplary embodiments thereof, it will be understood by those skilled in the art that various changes and modification in forms and details may be made without departing from the spirit and scope of the present invention as defined by the appended claims.

1. A 1-panel display apparatus comprising:
a plurality of monochromatic light sources irradiating illumination light beams having different wavelengths;
an optical modulator receiving sequentially the illumination light beams and modulating the illumination light beams in accordance with a control signal;
a scanner scanning the modulated illumination light beams sequentially on a display screen; and
a control unit receiving an image signal and outputting a control signal for controlling the monochromatic light source, the optical modulator and the scanner in correspondence to the image signal,
whereas the control unit controls an on/off timing of the monochromatic light source and an image data timing of the optical modulator in such a manner that a position of the modulated illumination light beam is equal to a position of a monochromatic image scanned on the display screen.

2. The 1-panel display apparatus of claim 1, wherein the on/off timing is synchronized with the image data timing.

3. The 1-panel display apparatus of claim 1, wherein the scanner unidirectionally rotates.

4. The 1-panel display apparatus of claim 1, wherein the scanner bidirectionally rotates.

5. The 1-panel display apparatus of claim 1, wherein a scanning direction is from one side to the other, and the control unit controls the on/off timing and the image data timing to be slow when the monochromatic scanned image is shifted to the one side, and controls the on/off timing and the image data timing to be fast when the monochromatic scanned image is shifted to the other side

6. The 1-panel display apparatus of claim 1, wherein the monochromatic scanned image comprises both a frame area representing image information and an over-scan area at both sides of the frame area in accordance with mechanical drive characteristics of the scanner.

7. The 1-panel display apparatus of claim 6, wherein the control unit varies the size of the over-scan area provided at both sides of the frame area in accordance with a degree of shift of the monochromatic scanned image.

8. A multi-panel display apparatus comprising:
a plurality of monochromatic light sources irradiating illumination light beams having different wavelengths;
a plurality of optical modulators receiving the illumination light beams and modulating the illumination light beams in accordance with a control signal;
a color synthesis optical system synthesizing the modulated illumination light beams;
a scanner scanning the light beam synthesized by the color synthesis optical system on a display screen; and
a control unit receiving an image signal and outputting a control signal for controlling a plurality of the monochromatic light sources, a plurality of the optical modulators and the scanner in correspondence to the image signal,
whereas the control unit controls an on/off timing of the monochromatic light source and an image data timing of the optical modulator in such a manner that a position of the modulated illumination light beam is equal to a position of a monochromatic image scanned on the display screen.

9. The multi-panel display apparatus of claim 8, wherein the on/off timing is synchronized with the image data timing.

10. The multi-panel display apparatus of claim 8, wherein the scanner unidirectionally rotates.

11. The multi-panel display apparatus of claim 8, wherein the scanner bidirectionally rotates.

12. The multi-panel display apparatus of claim 8, wherein a scanning direction is from one side to the other, and the control unit controls the on/off timing and the image data timing to be slow when the monochromatic scanned image is shifted to the one side, and controls the on/off timing and the image data timing to be fast when the monochromatic scanned image is shifted to the other side

13. The multi-panel display apparatus of claim 8, wherein the monochromatic scanned image comprises both a frame area representing image information and an over-scan area at both sides of the frame area in accordance with mechanical drive characteristics of the scanner.

14. The multi-panel display apparatus of claim 13, wherein the control unit varies the size of the over-scan area provided at both sides of the frame area in accordance with a degree of shift of the monochromatic scanned image.

15. A method for compensating a beam alignment in a display apparatus in which light beams are sequentially irradiated from a plurality of monochromatic light sources and an illumination light beam modulated by an optical modulator is scanned on a display screen, the method comprising:
judging a degree of shift of a monochromatic scanned image formed on the display screen; and
determining a frame image output timing of the monochromatic scanned image on the basis of a scanning direction of the monochromatic scanned image and the degree of shift.

16. The method of claim 15, wherein a scanning direction of the determining is from one side to the other, and the determining controls the on/off timing of the monochromatic light source and the image data timing of the optical modulator to be slow when the monochromatic scanned image is shifted to the one side, and controls the on/off timing and the image data timing to be fast when the monochromatic scanned image is shifted to the other side.

17. A computer-readable recording medium for recording a program executable by a computer, which executes a method for compensating a beam alignment in a display apparatus in which light beams are sequentially irradiated from a plurality of monochromatic light sources and an illumination light beam modulated by an optical modulator is scanned on a display screen, the program comprising:
judging a degree of shift of a monochromatic scanned image formed on the display screen; and
determining a frame image output timing of the monochromatic scanned image on the basis of a scanning direction of the monochromatic scanned image and the degree of shift.
